(19) United States
(12) Patent Application Publication
(10) Pub. No.: US 2012/0109888 A1
(43) Pub. Date: May 3, 2012

(54) DATA PARTITIONING METHOD OF DISTRIBUTED PARALLEL DATABASE SYSTEM

(75) Inventors: Weiping ZHANG, Chaoyang (CN); Songbo Zhang, Chaoyang (CN); Weihuai Liu, Chaoyang (CN)

(73) Assignee: BEIJING BORQS SOFTWARE TECHNOLOGY CO., LTD., Chaoyang (CN)

(21) Appl. No.: 13/325,810

(22) Filed: Dec. 14, 2011

Related U.S. Application Data
(63) Continuation of application No. PCT/CN2010/077565, filed on Oct. 1, 2010.

(30) Foreign Application Priority Data
Jul. 28, 2010 (CN) 201010239656.6

(51) Int. Cl. G06F 17/30

(52) U.S. Cl. 707/610; 707/E17.005

(57) ABSTRACT

A data partitioning method for a distributed parallel database system, comprising creating fact tables and dimension tables according to a constructed distributed parallel database system, inserting records of the dimension tables and the fact tables into nodes according to partitioning rules, replicating the records of dimension tables into the nodes that include fact tables, performing data deletion, and performing data update.

### CROSS-REFERENCE TO RELATED APPLICATIONS

This application is a continuation of International Patent Application No. PCT/CN2010/077565, filed on Oct. 1, 2010, which claims foreign priority from CN Application No. 201010239656.6, filed on Jul. 28, 2010, the disclosures of each of which are incorporated herein by reference in their entirety.

### FIELD

The present disclosure generally relates to a distributed parallel database system, and in particular to a data partitioning method for a distributed parallel database system.

### BACKGROUND

It is a common data management method to store data in a database, such as a relational database. According to the demand for data to be managed, a mature database management system (DBMS) can be selected, and a standard data definition language (such as SQL DDL) can be used to define a database schema that contains tables or relations, data structures, indices, a primary key, a foreign key, etc., and to deploy the database system. Then, an application program can manipulate the data, using functions such as, insert, query, update, import, and export, etc., with the data manipulation language (such as SQL DML) provided by the DBMS.

Nowadays, in many industrial applications, the volume of generated or accumulated data is huge, such as data sets of interne of things (iot) sensor data, financial transaction data, e-commerce goods data, and company sales data. These data sets may reach a large scale of hundreds of terabytes (TBs) or petabytes (PBs). Moreover, the data generation rate further increases as the time goes and the business grows. There is a higher requirement for data manipulation efficiency (such as query speed) of such massive data.

A single-node database system may no longer be competent for the management of massive data, due to its limited computation and storage capacity. A database or data warehouse system having distributed parallel structure or massively parallel processing (MPP) structure can provide better flexibility and extensibility on capacity and performance, wherein, the multi-node shared-nothing cluster architecture has been proved to have advantages in management of massive data.

The architecture of a shared-nothing multi-node distributed parallel database system is shown in FIG. 1. A global partitioner is implemented in the front-end server for partitioning or sharding of respective data table by a certain rule (for example, by time period or hash value of a specific attribute domain in the data tables), and distributing and storing the data in multiple different storage or processing nodes (e.g., nodes 1˜n in FIG. 1). The data partition or fragment assigned to the node by the partitioner is managed by a local database instance that operates in each node. Also, at the same time, a global querier that operates in the front-end server analyzes the specific query initiated by an application, and dispatches the query to the database system instances in the nodes; the local queriers in the nodes handle the query, and return the result to the global querier for further treatment (e.g., merge and sort operation). Finally, the data is returned to the corresponding application.

When the partitioner performs partitioning for the data tables, it employs a partitioning method such as round robin partitioning, hash partitioning, range partitioning, or list partitioning, and dispatches the data to corresponding nodes. Since the employed partitioning method acts on each data table separately, for a complex relation query that involves multiple data tables, especially a query that involves join action among multiple tables, when the global querier dispatches the query to the local queriers in the nodes corresponding to the partitions, according to the partitioning information of any table involved in the join query predicate, for other tables involved in the join predicate, each node has to copy and transport data from the partitions in other nodes. The inter-node data transport during such a query is also referred to as dynamic repartitioning, which not only consumes network bandwidth, but also requires transport time, resulting in greatly increased query response time which affects query efficiency.

### SUMMARY

To solve, or at least reduce, the effects of some of the above-mentioned drawbacks, an embodiments of the present disclosure provide a data partitioning method for a distributed parallel database system to eliminate inter-node data copy and transport during query, and thereby to improve query response rate and efficiency.

In an embodiment, the present disclosure provides a data partitioning method for a distributed parallel database system which includes the following steps:
Creating fact tables and dimension tables according to the constructed distributed parallel database system and distribution rules, and inserting the records of fact tables and records of dimension tables into nodes;
Replicating the records of dimension tables to the nodes for the fact tables; and
Performing data deletion and update.

In accordance with embodiments of the present disclosure, when the partitions of a data set or data stream are imported or inserted into a distributed database system, the inter-table relation defined by the database schema, especially the primary-foreign key constraint condition, can be met in each node, so that the data in each node has local data completeness. In order to perform a query that involves join among tables by utilizing the primary-foreign key constraint conditions, since the data in each node has local completeness for such a query, no dynamic data repartitioning is required among the nodes; therefore, the time-consuming network transmission of data is avoided, and thereby the query response time is reduced and the query efficiency is improved.

For purposes of summarizing the disclosure, certain aspects, advantages and novel features of the inventions have been described herein. It is to be understood that not necessarily all such advantages can be achieved in accordance with any particular embodiment of the inventions disclosed herein. Thus, the inventions disclosed herein can be embodied or carried out in a manner that achieves or optimizes one advantage or group of advantages as taught herein without necessarily achieving other advantages as can be taught or suggested herein.

### BRIEF DESCRIPTION OF THE DRAWINGS

The accompanying drawings are provided to help further understanding of the present disclosure, and constitute a part of the specification. These drawings are used to illustrate certain embodiments of the present disclosure, but do not constitute any limitation to the present disclosure. In the drawings:

FIG. 1 shows the architecture of a prior art shared-nothing multi-node distributed parallel database system.

FIG. 2 is a flow diagram of a data partitioning method of a distributed parallel database system, in accordance with an embodiment of the disclosure.

FIG. 3 is a relation diagram of a fact table and a dimension table.

FIG. 4 is a relationship diagram of data tables partitioned in a single star configuration.

FIG. 5 is a distribution graph of data after the records of dimension tables are inserted.

FIG. 6 is a schematic diagram of data distribution after the records of fact tables are inserted.

FIG. 7 is a schematic diagram of initial values of a bloom filter bit array.

FIG. 8 is a schematic diagram of setting the bit array according to a hash function value of x.

FIG. 9 is a schematic diagram of judging whether y belongs to the set.

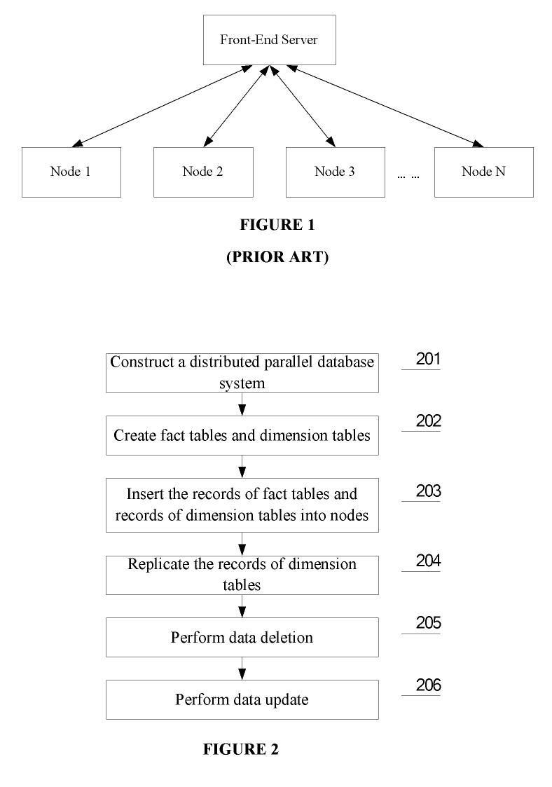

### DETAILED DESCRIPTION

Hereunder, embodiments of the invention will be described with reference to the accompanying drawings. It should be appreciated that the embodiments described herein are only provided to describe and interpret the disclosure, but do not constitute any limitation to the disclosure.

In an embodiment, when a database system is constructed or a data warehouse is constructed on the basis of a distributed database, the actual fact data and the data for describing an attribute may be separated by different tables. The actual fact data can be stored in tables that are called fact tables, while the data that describe attributes from different aspects can be stored in different dimension tables. For example, a sales database or data warehouse can be designed as follows: each sales record can contain a sales product, a sales customer, a product supplier, a sales time, a sales volume, and a sales revenue, etc. A detailed numeric type data, such as sales volume and sales amount, can be the object to be analyzed by the system. As for data such as time, product, customer, and supplier, it can be expected to obtain a statistical result of the numeric type data from these different aspects. Therefore, numeric type data can be stored in fact tables, while time, product, customer, and supplier can be stored in different dimension tables. In some embodiments, there can be a primary-foreign key relation between dimension tables and fact tables, while no relation may exist between dimension tables.

In some embodiments, the relations and attributes of the database system can be modeled in a manner similar to the manner mentioned above. Since different data tables can be divided into dimension tables and fact tables and associated with each other by primary-foreign key association, topologically, fact tables can be located at the center, while dimension tables can surround the fact tables, forming a star structure; therefore, such a model of a database system can be called a star schema. The fact tables may contain only numeric type data, except for the foreign key for distinguishing each record (the primary key for correlating dimension tables). Therefore, each record in a fact table can be called a “measurement” because each record can be a basic element (i.e., a measurement value when utilizing the database or data warehouse for statistical analysis). In the query and analysis of a database system, the query can be handled based on the analysis and process of measurements (i.e., measurements in fact tables). In other words, a predicate related with the fact table can exist in the query predicate.

In some embodiments, star schema is the principal schema for modeling the relationships and data of a database system or data warehouse. In some embodiments, the schema derived from star schema is a snowflake schema. Snowflake schema can be a schema obtained by normalizing the dimension tables on the basis of star schema. Since a star topology or multi-level star topology can be obtained when each dimension table is normalized, the entire schema can be similar to a snowflake in shape topologically, and therefore it can be called a snowflake schema. Snowflake schema can be more complex than star schema, and therefore more tables may have to be related during queries.

FIG. 2 is a flow diagram of the data partitioning method of a distributed parallel database system. Hereunder, the data partitioning method of the distributed parallel database system will be described in detail with reference to FIG. 2.

At block 201, a distributed parallel database system can be constructed according to a property of data to be managed and the number of nodes. For example, in a sales database or data warehouse, the constructed data tables can comprise data such as sales product, sales customer, product supplier, sales time, sales volume, and sales amount.

At block 202, fact tables and dimension tables can be created. Fact tables used to store actual fact data can be created. The primary keys and foreign keys of the fact tables can be defined, and records of fact data can be inserted into the fact tables, wherein, the fact data can be specific numeric type data, such as sales volume and sales amount in the above-mentioned sales database or data warehouse. Dimension tables used to store data describing the attributes from different aspects can be created. Primary keys of the dimension tables can be defined, and records of the data describing attributes can be inserted into the dimension tables, wherein the data describing the attributes can be time, product, customer, or supplier data of above-mentioned sales database or data warehouse. The fact tables and dimension tables can be related with each other with foreign keys of the fact tables and primary keys of the dimension tables.

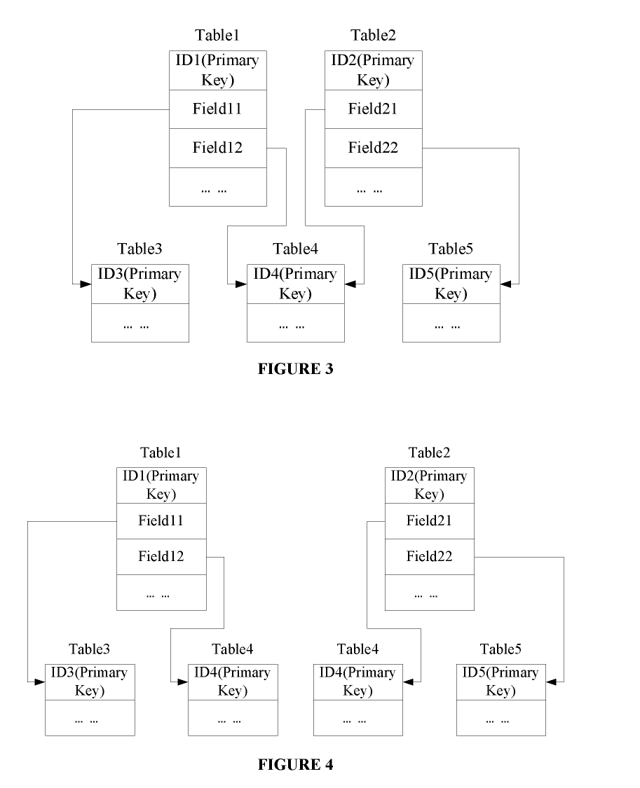

FIG. 3 is a relation diagram between a fact table and a dimension table. As shown in FIG. 3, Table1 and Table2 can be defined as fact tables, while Table3, Table4, and Table5 can be defined as dimension tables. In some embodiments, the foreign key Field11 of Table1 is related with the primary key ID3 of Table3, the foreign key Field12 of Table1 and foreign key Field21 of Table 2 are both related with the primary key ID4 of Table4, and the foreign key Field22 of Table2 is related with the primary key ID5 of Table5.

FIG. 4 is a relationship diagram of data tables partitioned in a single star construction. As shown in FIG. 4, according to the relation diagram between the fact table and the dimension table shown in FIG. 3, the dimension table Table4 can be partitioned into two logical tables, each of which is in a single star type structure; however, the dimension table Table4 can still be one table physically.

At block 203, the records of fact tables and records of dimension tables can be inserted into the nodes. In an embodiment, the records of fact tables and the records of dimension tables are inserted into different nodes according to a partitioning strategy.

At block 204, the records of dimension tables can be replicated. After the records of fact tables are inserted, to ensure local completeness of the data, the records of dimension tables related with the records of fact tables by foreign keys can be replicated to the node. Thus, when table joins form a join table, it may be unnecessary to transport data from other nodes; therefore, the network expense can be reduced.

In some embodiments, a method for determining the replication of records of dimension tables to a node of a fact table is as follows: first, only the dimension tables that are related with the fact table by the foreign keys may need replication; and second, the records of the dimension tables related by the foreign keys in the newly inserted records may need to be replicated to the same node that contains the records of the fact table. For example, if the foreign key in the records of the fact table has a value of X, the records of the dimension table with primary key value X may need to be replicated to the node. If the records of the fact table have multiple foreign keys, the records of the dimension tables related by each foreign key may need to be replicated. Due to the fact that a partition may take the primary key of a table as the keyword, it can be easy to find the node where the required records of the dimension table exist according to the foreign key value of the fact table (i.e., the primary key value of the dimension table).

FIG. 5 is a distribution graph of data after the records in dimension tables are inserted. As shown in FIG. 5, in the case of the star schema that comprises Table1, Table3 and Table4 in FIG. 4, the data distribution at each node after the records of the dimension tables (Table3 and Table4) are inserted can be seen in FIG. 5: before the records of the fact table are inserted, the records of dimension tables are non-overlapped at each node.

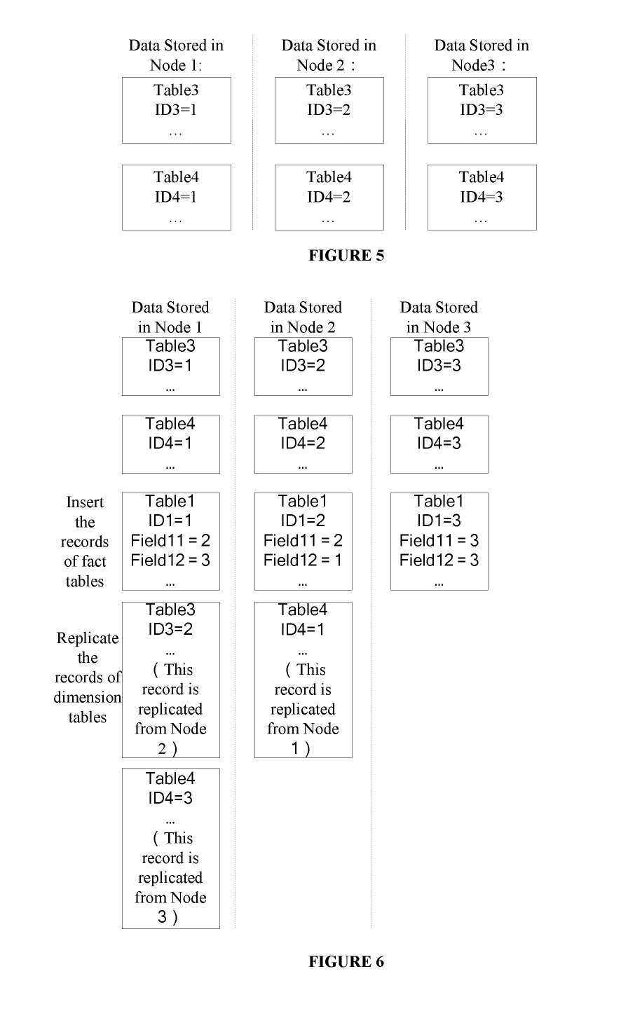

FIG. 6 is a schematic diagram of data distribution after the records of a fact table are inserted. As shown in FIG. 6, a record of Table1 can be inserted into node 1, and the records of Table3 and Table4 (ID3=2 and ID4=3, respectively) related by Field11 (value=2) and Field12 (value=3) do not yet exist in node 1; therefore, the records of these tables may need to be replicated from node 2 and node 3 respectively.

In some embodiments, a record of Table1 is inserted into node 2, and it is unnecessary to replicate the records of Table3 (ID3=2), related by Field11 (value=2), because the records already exist in node 2. However, the records of Table4 (ID4=1) related by Field12 (value=1) may need to be replicated from node 1 because the records do not exist in node 2.

In some embodiments, a record of Table1 is inserted into node 3, and it is unnecessary to replicate the records of Table3 and Table4 (ID3=3 and ID4=3, respectively), related by Field11 (value=3) and Field12 (value=3), because the records both already exist in node 3.

In some embodiments, as can be seen from the figures, after the records of a fact table are inserted, the records of dimension tables may be overlapped in different nodes; but the records of fact tables may be non-overlapped. The node to which a record is partitioned according to an initial partitioning strategy can be called a primary node for the record, while a node to which the records of dimension tables are replicated to maintain local completeness can be called a backup node for the record.

With the method described above, for query operations that involve join action, the system can quickly retrieve the records related by foreign keys because, in some embodiments, the same node already stores these related records and it is unnecessary to transport data every time; therefore, the query efficiency can be improved.

In some embodiments, for a query operation in dimension tables, the query request is dispatched by the front-end server to each node; each node retrieves the records stored locally, and then returns the records to the front-end server for summary. Due to the fact that the records of dimension table may be overlapped in different nodes, the records of dimension tables received by the front-end server may be repeated. To reduce or solve this problem, the repeated records can be filtered off in the front-end server, or a single node can be defined as primary node or backup node according to different records and then the records from backup nodes can be filtered off.

At block 205, data deletion can be performed. In some embodiments, the records of the fact tables are deleted; then, if the records of related dimension tables are no longer related with other fact tables, the records of related dimension tables in the node are deleted (except for the records in primary node). In some embodiments, for the deletion of records of the dimension tables, only the records in the primary node may need to be deleted, because the records of fact tables are deleted before the deletion of records of dimension tables, and the records of dimension tables in the node have been deleted when the records of fact tables are deleted.

At block 206, a data update can be performed. In an embodiment, after the records of a fact table are updated, if an update of foreign keys is related, the old records of dimension tables (except for the records in the primary node and records related with other fact tables) are deleted, and then new records of dimension tables are replicated; in an embodiment, for update of records of dimension tables, the records in the primary node are updated, and the records in backup nodes are updated too. The update of records of a dimension table can be accomplished by searching in the fact tables in all nodes for any foreign key in a fact table which is equal to the primary key of records of dimension table to be updated; if such a foreign key exists, the relevant records of dimension table in the node can be updated. Such a method may involve traversing the fact tables in all nodes and may take a longer time than is desired. In some embodiments, a method for updating the records of dimension tables advantageously includes creating a bloom filter table for each dimension table and each node to record the distribution of records of dimension tables in the nodes, and thereby the node that stores a specified record can be found easily.

In some embodiments, a bloom filter is a random data structure that has very high spatial efficiency. The bloom filter can utilize a bit array to represent a set simply, and can judge whether an element belongs to the set. A bloom filter can achieve such high efficiency at some cost: when it is used to judge whether an element belongs to certain set, it is possible that an element that doesn't belong to the set can be mistaken as an element of the set (false positive). Therefore, a bloom filter may not be suitable for “zero-error” applications. However, in applications where a low error rate is tolerable, a bloom filter can achieve very high spatial efficiency at the cost of a few errors.

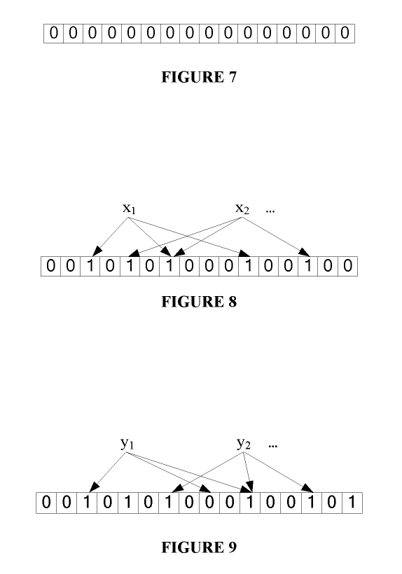

In some embodiments, a bloom filter can represent a set with a bit array. FIG. 7 is a schematic diagram of initial values of a bloom filter bit array. As shown in FIG. 7, in the initial state, the bloom filter is a bit array that can include m bits, each of which is set to 0.

In some embodiments, to represent a set with n elements, such as S={x₁, x₂, . . . xₙ}, a bloom filter uses k hash functions independent from each other, which can map each element in the set to a range of {1, . . . , m} respectively. For any element x, the position hf(x) mapped by the f^{th} hash function can be set to 1 (1≦f≦k). Note that if a position is set to 1 for several times, only the first setting may be effective and the following settings may have no effect.

FIG. 8 is a schematic diagram of setting a bit array in accordance with the hash function values of x. As shown in FIG. 8, k=3, and two hash functions can select the same bit (the 7^{th} bit when counted from left to right).

In some embodiments, to judge whether y belongs to the set, k orders of hash functions can be applied to y; if the positions of all hf(y) are 1 (1≦f≦k), y can be judged as an element of the set; otherwise, y is not an element of the set.

FIG. 9 is a schematic diagram of judging whether y belongs to a set. As shown in FIG. 9, y1 is not an element of the set, while y2 belongs to the set or is a false positive exactly.

In computer science, a common tradeoff is sacrificing time for space or sacrificing space for time (i.e., to achieve an optimum in one aspect at the cost of another aspect). In an embodiment, a bloom filter introduces an additional factor: error rate, in addition to time and space. There can be an error rate when the bloom filter is used to judge whether an element belongs to a certain set. That is to say, an element that doesn't belong to the set may be mistaken as an element of the set (false positive); but it may be impossible that an element of the set is mistaken as an element that doesn't belong to the set (false negative). After the error rate factor is introduced, the bloom filter can save storage space significantly by allowing for a few errors.

In some embodiments, the distribution of records of each dimension table in each node is recorded in a bloom filter table, wherein, the primary key of the dimension table is taken as the keyword for query in the bloom filter table, and the quantity of bloom filter tables is equal to a quantity of dimension tables multiplied by a quantity of nodes. If a bloom filter identifies a mistake (false positive), the consequence can be that the system attempts to update a record of a dimension table in a node, but the record doesn't exist in the node. Such an error will not affect data validity and consistency, and therefore may be tolerable. Moreover, as long as the hash algorithm and the length of bit array are selected appropriately, the error rate may be very low.

In some embodiments, these bloom filter tables can be stored in the front-end server as a global data set, or distributed and stored in the nodes; in the latter case, each node can be responsible for recording the distribution of records of dimension tables in it. Since the bloom filter tables may occupy little space, these tables can be loaded into the memory in advance during practice to improve the query speed.

The data partitioning methods provided in the present disclosure can be applied to distributed database systems in which the query operations involve a join action among a great deal of relevant tables. For example, in management of goods data, the user often needs to sort the data by category or price, etc. According to some aspects of the present disclosure, the categories and price can be defined in a fact table, and some dimension tables related by foreign keys can be defined, such as seller and manufacturer. When the records of fact table are inserted, the records of related dimension tables can be replicated to the same node. When performing a join query among related category/price/seller/manufacturer tables, the front-end server can dispatch the query to each node, and each node can perform a join operation without retrieving data from other nodes; thus, the query efficiency can be improved greatly. The nodes can then return their results to a global querier for summary.

In the management of sales data, the sales amount and profit value can be defined in a fact table, while the customer and sales time can be defined in dimension tables, which are related with the fact table via primary and foreign keys. When the records of a fact table are inserted into a node, the records of related dimension tables can be replicated to the same node. To perform statistics on the sales amount of a certain customer, the front-end server can dispatch the statistical work to the nodes. Relying on the data stored locally, each node can judge easily whether the sales records in the fact table belong to the customer or not, since, in some embodiments, the information of the customer already exists in the node; thus, the local statistical work easily can be easily accomplished, and can be sent to the front-end server for summary.

In some embodiments, when the partitions of a data set or a data stream are imported or inserted into a distributed database system, the inter-table relation defined by the database schema, especially the primary-foreign key constraint conditions, can be met in each node so that the data in each node can have local data completeness. For a query that involves a join action of tables with the primary-foreign key constraint conditions, since the data in each node can have local data completeness for such a query, no dynamic data repartitioning may be required among the nodes. Therefore, the time of network transmission of data can be avoided, and thereby the query response time can be reduced and the query efficiency can be improved.

Many other variations than those described herein will be apparent from this disclosure. For example, depending on the embodiment, certain acts, events, or functions of any of the algorithms described herein can be performed in a different sequence, can be added, merged, or left out all together (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. A computing environment can include any type of computer system, including, but not limited to, a computer system based on a microprocessor, a mainframe computer, a digital signal processor, a portable computing device, a personal organizer, a device controller, and a computational engine within an appliance, to name a few.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others.

What is claimed is:

1. A data partitioning method of a distributed parallel database system, the data partitioning method comprising:
creating fact tables and dimension tables according to a constructed distributed parallel database system and distribution rules;
inserting records of the fact tables and records of the dimension tables into nodes;
replicating the records of the dimension tables to nodes of the fact tables;
performing data deletion; and
performing a data update.

2. The data partitioning method of a distributed parallel database system according to claim 1, wherein the fact table comprises a primary key, a foreign key, and the records of the fact table.

3. The data partitioning method of a distributed parallel database system according to claim 1, wherein the dimension table comprises a primary key and the records of the dimension table.

4. The data partitioning method of a distributed parallel database system according to claim 1, wherein the fact tables and dimension tables are related with a primary key and a foreign key, and wherein a value of the foreign key of the fact table is equal to a value of the primary key of a related dimension table.

5. The data partitioning method of a distributed parallel database system according to claim 1, wherein said inserting records of fact tables and records of dimension tables into nodes comprises inserting the records of the fact tables and the records of the dimension tables into different nodes.

6. The data partitioning method of a distributed parallel database system according to claim 1, wherein said replicating the records of the dimension tables to nodes of the fact tables comprises:
determining related dimension tables according to foreign keys in the fact tables; and
replicating records of the related dimension tables to the node that contains the fact table.

7. The data partitioning method of a distributed parallel database system according to claim 1, wherein said performing data deletion comprises:
deleting the records of the fact tables;
deleting the records of the dimension tables related with the fact tables in the node; and
keeping the records of the dimension tables in a primary node.

8. The data partitioning method of a distributed parallel database system according to claim 1, wherein said performing a data update comprises:
updating records of each dimension table in a certain node;
searching for the fact tables related with the dimension tables; and
updating the related dimension tables in the nodes that contain the fact tables.

9. The data partitioning method of a distributed parallel database system according to claim 1, wherein said performing data update comprises creating a bloom filter table for each dimension table and each node to record a distribution of the records of each dimension table in each node, to find a node that stores a specified record, and to update each dimension table in the node.

10. The data partitioning method of a distributed parallel database system according to claim 9, wherein the bloom filter table is stored in a front-end server or in each node.

11. The data partitioning method of a distributed parallel database system according to claim 1, wherein said creating fact tables, said replicating the records of the dimension tables, said performing data deletion, and said performing a data update are performed by a general purpose processor.
